(19) United States
(12) Patent Application Publication
(10) Pub. No.: US 2003/0001304 A1
(43) Pub. Date: Jan. 2, 2003

(54) Process for the manufacture of boards of ligneous material

(75) Inventor: Matthias Graf, Bretten (DE)

Correspondence Address: FOLEY AND LARDNER, SUITE 500, 3000 K STREET NW, WASHINGTON, DC, 20007, US

(73) Assignee: Maschinenfabrik J. Dieffenbacher GmbH & Co.

(21) Appl. No.: 10/178,788

(22) Filed: Jun. 25, 2002

(30) Foreign Application Priority Data
Jun. 25, 2001 (DE) 101 30 509.5

(51) Int. Cl. B27N 3/00

(52) U.S. Cl. 264/109; 264/122; 264/138

(57) ABSTRACT

A process for manufacturing ligneous material board with improved surface slip-resistance. The process includes a mechanical ablation step which roughens the surfaces of the board to obtain slip-resistant textured surfaces.

### BACKGROUND OF THE INVENTION

The present invention relates to a process for the manufacture of boards of ligneous material. The term “ligneous material boards” includes flake boards and fiber boards. One form of the process from which the invention is set out forms a board from a mixture of lignocellulose and/or cellulose particles, such as flakes, fibers, and chips or the like, treated with a binding agent wherein the individual particles are spread from a spreading station onto a moving belt to form a mat of material to be pressed, and after transfer to a continuously operating multilayer press, they are pressed with the application of pressure and heat and cured, and thereafter the just-finished ligneous material board released from the pressing process is sprayed with water on both surfaces and subjected to a texturing process.

One such process is the subject of German patent application DE 197 18 771 A1, filed Jul. 5, 1997, which is hereby incorporated by reference. The aforementioned patent application discloses a process in which a board of ligneous material, still hot after leaving the hot press, is provided with a screen impression on one or both surfaces. Especially in the case of manufacturing processes in which the manufacture of the board of ligneous material is performed on a continuous press, it has been found that a pronounced glossy layer is formed on the surfaces of the boards. This glossy layer gives the board a surface quality which is comparable in appearance to a glaze or varnish coating. By the subsequent embossing process the desired screen printing texture is embossed into one or both surfaces. Glossy areas remain visible after the hot pressing, which result in an impairment of the slip and stick properties of the embossed pattern. It has also been found that the glossy layer reduces the moisture absorption capacity of the boards after the hot pressing operation, so that the water sprayed on ahead of the embossing press to soften the surface layer is unable to penetrate fully into the wood, and the deficient softening impairs the quality of the embossed texture.

One problem addressed by the invention is finding a process by which the stated disadvantages are avoided.

### SUMMARY OF THE INVENTION

According to one embodiment of the present invention, a solution to this problem comprises a process wherein immediately following the continuously operating press, the glossy layer is partially removed or completely removed from one or both surfaces of the ligneous material board by mechanical ablation. This increases the moisture absorption capacity of the board and ultimately results in improved slip and stick surface characteristics.

According to another embodiment of the present invention, a process for manufacturing a ligneous material board having a slip resistant surface is provided. The process involves spreading a mixture of binding agent and lignocellulose and/or cellulose particles onto a moving belt to form a mat and then pressing and curing the mat to form a board. The formed board has top and bottom surfaces with a glossy layer on each surface. The glossy layer is partially or completely removed by mechanical ablation, which results in a roughened, slip resistant surface. The glossy layer can be ablated by moving an ablation apparatus, such as a roughening brush or grinding apparatus, across the surface of the glossy layer. Mechanical ablation can be performed at an angle to the board's direction of advancement or in a series of steps, where the ablation is performed alternately in the direction of the board's advancement and against the direction of the board's advancement. Following the ablation process, which might remove 0.01 to 0.1 mm from the thickness of the glossy layer, the top and bottom surfaces of the board are sprayed with water, and the board is subjected to a texturizing process.

Another embodiment of the present invention provides a process for manufacturing a ligneous material board comprising forming a mat of ligneous material having top and bottom surfaces and then pressing and curing the mat in a press. This process forms a glossy layer over the top and bottom surfaces of the board. One or both glossy layers can be ablated by moving an ablating apparatus, such as a roughening brush or grinding apparatus, across the glossy layer. The ablating step can occur after the pressing and curing step, and an additional step of spraying water on both surfaces can be added. The ablating step, which might remove 0.01 to 0.1 mm from the thickness of the glossy layer, can be performed at an angle to the board's direction of advancement or in a series of steps, where the ablation is performed alternately in the direction of the board's advancement and against the direction of the board's advancement.

### DETAILED DESCRIPTION OF THE PREFERRED EMBODIMENTS

With the invention a process is indicated in which the glossy layer, such as is formed especially in the continuous manufacture of ligneous material boards, is partially removed by mechanical ablation on one or both sides of ligneous material boards. For this purpose an additional unit is installed immediately following the hot press, which removes the glossy layer, by means of a roughening brush for example, down to a thickness of 0.01 to 0.1 mm. The removal of the glossy layer is performed before the application of a spray of water, i.e., before the actual embossing begins.

In addition to the actual removal of the glossy layer and the elimination of the above-described disadvantages, an additional roughening of the surface is achieved by the roughening brush. Thus, individual fibers among other things are torn out of the bond and then protrude from the surface. Both effects lead to an improvement of the slip and stick properties of the ligneous material board and additionally improve the quality of the embossed texture. Instead of a roughening brush, a suitable grinding apparatus can achieve equally good results. For various reasons it may be necessary to perform the ablation of the glossy layer in several steps, wherein the ablation is performed, not parallel to the direction of advancement but also at an angle to the direction of advancement, a small angle being sufficient as a rule to provide for an automated carrying away of the held material. Also, it is practical to perform the ablation of the glossy layer in a plurality of successive steps alternating with and against the direction of advancement, which means that, in the case of an arrangement, for example, of several brush cylinders, the first and third operate against the direction of movement of the flake board and the second and fourth brush in the direction of movement.

To improve the useful life the direction of movement of the brushes can be changed by a simple change of direction or by exchanging them.

The priority document here, German patent application 101 30 509.5, filed Jun. 25, 2001, is hereby incorporated by reference.

What is claimed is:

1. A process for manufacturing a ligneous material board having a slip resistant surface, comprising the steps of:
providing a mixture of a binding agent and lignocellulose particles, cellulose particles, or lignocellulose and cellulose particles;
spreading the mixture onto a moving belt to form a mat;
pressing and curing the mat to form a board having top and bottom surfaces with a glossy layer on each of the top and bottom surfaces;
mechanically ablating at least one of the glossy layers to thereby form a board having a roughened, slip resistant surface; and
spraying the top and bottom surfaces of the board with water.

2. The process of claim 1, wherein only a portion of one of the glossy layers is ablated.

3. The process of claim 1, wherein the mechanically ablating step comprises moving an ablation apparatus across the surface of the at least one of the glossy layers.

4. The process of claim 3, wherein the mechanically ablating step is performed with a roughening brush.

5. The process of claim 3, wherein the mechanically ablating step is performed with a grinding apparatus.

6. The process of claim 3, wherein the mechanically ablating step is performed at an angle to a direction of advancement of the board.

7. The process of claim 3, wherein the mechanically ablating step is performed in a plurality of successive steps alternately in a direction of the board's advancement and against the direction of the board's advancement.

8. The process of claim 1, wherein the mechanically ablating step includes removing a thickness of 0.01 to 0.1 mm from the at least one of the glossy layers.

9. A process for manufacturing a ligneous material board, comprising the steps of:
forming a mat of ligneous material having top and bottom surfaces;
pressing and curing the mat in a press to thereby form a glossy layer over each of the top and bottom surfaces;
ablating at least one of the glossy layers by moving an ablating apparatus across the glossy layer.

10. The process of claim 9, wherein the ablating step occurs after the pressing and curing step.

11. The process of claim 9, further comprising the step of spraying water on both surfaces after the ablating step.

12. The process of claim 9, wherein the ablating step is performed with a roughening brush.

13. The process of claim 9, wherein the ablating step is performed with a grinding apparatus.

14. The process of claim 9, wherein the ablating step is performed at an angle to a direction of advancement of the board.

15. Process of claim 9, wherein the ablating step is performed in a plurality of successive steps alternately in a direction of advancement of the board and against the direction of advancement of the board.

16. The process of claim 9, wherein the ablating step removes a thickness of 0.01 to 0.1 mm from at least one of the glossy layers.
